(19) United States
(12) Patent Application Publication
(10) Pub. No.: US 2024/0236589 A1
(43) Pub. Date: Jul. 11, 2024

(54) MAGNETIC CONNECTOR FOR A GALVANIC CHARGING CONNECTION OF AN ELECTRONIC DEVICE, IN PARTICULAR A HEARING INSTRUMENT, MAGNETIC MATING CONNECTOR, MAGNETIC CONNECTOR SYSTEM, ELECTRONIC DEVICE AND CHARGER

(71) Applicant: Sivantos Pte. Ltd., Singapore (SG)

(72) Inventor: Johannes Kuhn, Erlangen (DE)

(21) Appl. No.: 18/616,258

(22) Filed: Mar. 26, 2024

Related U.S. Application Data
(63) Continuation of application No. PCT/EP2022/077000, filed on Sep. 28, 2022.

(30) Foreign Application Priority Data
Sep. 28, 2021 (DE) 10 2021 210 852.0

(51) Int. Cl. H04R 25/00; H04R 1/10

(52) U.S. Cl. CPC H04R 25/556; H04R 1/1025; H04R 2225/31; H04R 2420/09

(57) ABSTRACT

A magnetic connector for a galvanic charging connection of an electronic device, in particular a hearing aid, includes a cylindrical first contact of a magnetic or magnetizable material and a second contact disposed adjacent thereto. The second contact is formed of a non-magnetic or non-magnetizable material or a material being less magnetizable than the material of the first contact and/or contains less material than the first contact. A corresponding magnetic mating connector of a charger or charging cable includes a first mating contact and a second mating contact. The mating connector further includes a magnet aligned flush with the first mating contact. A mating contact surface of the second mating contact is annular or in the shape of a ring segment and surrounds the first mating contact. A magnetic connector system, an electronic device or hearing instrument and a charger or charging cable are also provided.

### CROSS-REFERENCE TO RELATED APPLICATION

This application is a continuation, under 35 U.S.C. § 120, of copending International Patent Application PCT/EP2022/077000, filed Sep. 28, 2022, which designated the United States; this application also claims the priority, under 35 U.S.C. § 119, of German Patent Application DE 10 2021 210 852.0, filed Sep. 28, 2021; the prior applications are herewith incorporated by reference in their entirety.

### FIELD AND BACKGROUND OF THE INVENTION

The invention relates to a magnetic connector for a galvanic charging connection of an electronic device, in particular a hearing instrument. The invention further relates to a magnetic mating connector of an electrical charger or charging cable, and to a connector system formed by the connector and the mating connector.

A hearing instrument generally refers to an electronic device that supports the hearing of a person wearing the hearing instrument (hereinafter referred to as the “wearer” or “user”). In particular, the invention relates to hearing instruments which are provided to compensate, in whole or in part, for a hearing loss of a hearing-impaired user. Such a hearing instrument is also referred to as a “hearing aid.” In addition, there are hearing instruments that protect or improve the hearing of users with normal hearing, for example to enable improved speech comprehension in complex hearing situations.

Hearing instruments in general, and hearing aids in particular, are usually configured to be worn on the head and in particular on an ear of the user, in particular as behind-the-ear devices (also referred to as BTE devices) or in-the-ear devices (also referred to as ITE devices). In terms of their internal structure, hearing instruments regularly have at least one (acoustoelectrical) input transducer, a signal processing unit (signal processor) and an output transducer. During operation of the hearing instrument, the or each input transducer picks up an airborne sound from the environment of the hearing instrument and converts that airborne sound into an input audio signal (i.e., an electrical signal that carries information about the ambient sound). In the signal processing unit, the or each input audio signal is processed (i.e., modified with respect to its sound information) to support the user's hearing, in particular to compensate for a hearing loss of the user. The signal processing unit outputs an appropriately processed audio signal to the output transducer.

In most cases, the output transducer is configured as an electroacoustic transducer that converts the (electrical) output audio signal back into an airborne sound, wherein that airborne sound—modified compared to the ambient sound—is emitted into the user's ear canal. In the case of a hearing instrument worn behind the ear, the output transducer, also known as the “receiver,” is usually integrated outside the ear in a housing of the hearing instrument. In that case, the sound emitted by the output transducer is directed into the user's ear canal by using a sound tube. Alternatively, for that purpose the output transducer can also be located in the ear canal, and therefore outside the housing worn behind the ear. Such hearing instruments are also referred to as RIC devices (from the term “receiver in canal”). Hearing instruments worn in the ear that are so small that they do not protrude beyond the ear canal are also referred to as CIC devices (as per the term “completely in canal”).

In other configurations, the output transducer can also be configured as an electromechanical transducer that converts the output audio signal into structure-borne sound (vibrations), wherein that structure-borne sound is emitted into the user's skull bone, for example. There are also implantable hearing instruments, in particular cochlear implants, and hearing instruments of which the output transducers directly stimulate the user's auditory nerve.

More recently, hearing instruments with rechargeable batteries have been increasingly produced. The battery is recharged there either wirelessly or by using a galvanic charging connection. A charging connection is generally defined as an electrical device for supplying a charging current, i.e., an electrical current for charging the rechargeable battery of the device. In contrast to wireless charging, “galvanic” means that the charging connection enables an electrical current flow (i.e., an exchange of electrons) between a charger or charging cable and the electrical device.

Compared to a wireless charger, a galvanic charging connection generally has the advantage that it is comparatively compact and can therefore be implemented in a space-saving manner. However, a disadvantage of conventional galvanic charging connections is that the electronic devices equipped with them must be positioned precisely in relation to the charger or charging cable for the charging process in order to close the galvanic (i.e., electrically conductive) connection. Galvanic charging connections are therefore often comparatively difficult to handle and—if handled incorrectly—susceptible to faults.

### SUMMARY OF THE INVENTION

It is accordingly an object of the invention to provide a magnetic connector for a galvanic charging connection of an electronic device, in particular a hearing instrument, a magnetic mating connector, a magnetic connector system, an electronic device and a charger, which overcome the hereinafore-mentioned disadvantages of the heretofore-known devices of this general type and which provides an easy-to-use and reliable galvanic charging system (not susceptible to faults) for an electronic device fitted with a rechargeable battery.

With the foregoing and other objects in view there is provided, in accordance with the invention, a magnetic connector for a galvanic charging connection of an electronic device, in particular a hearing instrument, comprising a cylindrical first contact and a second contact configured next to the first contact, the first contact being formed from a magnetic or magnetizable material, in particular from a ferrous steel, and the second contact being formed from a non-magnetic or non-magnetizable material or a material being less magnetizable in comparison with the material of the first contact, in particular from a titanium alloy or an austenitic chromium-nickel-molybdenum steel and/or contains less material than the first contact.

With the objects of the invention in view, there is also provided a magnetic mating connector of an electrical charger or charging cable, comprising a first mating contact which has a mating contact surface for forming a galvanic connection with a first contact of a magnetic connector of a charging connection of an electronic device, and a second mating contact, which has a mating contact surface for forming a galvanic connection with a second contact of the connector of the charging connection of the electronic device, and a magnet, in particular a permanent magnet, aligned flush with the first mating contact, the mating contact surface of the second mating contact being ring-shaped or ring-segment-shaped and surrounding the first mating contact.

With the objects of the invention in view, there is furthermore provided a magnetic connector system, comprising the magnetic connector according to the invention and the magnetic mating connector according to the invention.

With the objects of the invention in view, there is additionally provided an electronic device, in particular a hearing instrument, comprising a rechargeable battery and a galvanic charging connection for supplying an electric current for charging the battery, the charging connection having a magnetic connector according to the invention for producing a galvanic contact, held by magnetic force, with a magnetic mating connector of a charger or charging cable.

With the objects of the invention in view, there is concomitantly provided a charger or charging cable for supplying an electronic device, in particular a hearing instrument, with electric current for charging a rechargeable battery of the electronic device, comprising a mating connector according to the invention.

Advantageous embodiments and further developments of the invention are described in the dependent claims and in the description below and can be seen from the drawing.

The magnetic connector includes a cylindrical (i.e., pin-shaped, in particular circular-cylindrical) first contact and a second contact, each made of electrically conductive material. The magnetic connector is therefore multi-pole, in particular two-pole. The second contact is configured next to the first contact (i.e., offset transverse to the axis of the first contact) and is preferably also cylindrical (i.e., pin-shaped, in particular circular-cylindrical). The first contact and the second contact of the connector each have a contact surface which is provided for forming a galvanic connection with a respectively assigned mating contact surface of a magnetic mating connector of a charger or charging cable.

The first contact is made of a magnetic or magnetizable material, in particular a ferrous steel (e.g., SUS 430).

By contrast, the second contact is formed from a non-magnetic or non-magnetizable material or a material that is less magnetizable than the material of the first contact, in particular from a titanium alloy or an austenitic chromium-nickel-molybdenum steel (e.g., SUS316L, TiAl4V6 or BioDur108). Additionally or alternatively, the second contact is smaller than the first contact and therefore is formed of less material than the first contact. Within the scope of the invention, the respective material of the first and second contact can be formed from several material components, possibly with different physical properties. For example, the respectively desired electrical and magnetic properties of the first and second contact can be realized by several different material regions or layers.

The term “magnetic connector” is generally used to describe an electrical contact device that is configured to form a galvanic connection with a corresponding mating connector that is held by magnetic force; the magnetic connector either generates a (particularly permanent) magnetic field itself or is configured to be magnetized by a magnetic field generated by the mating connector. When in contact with the mating connector, the magnetic connector can optionally—like a conventional connector—also be held on the mating connector additionally by a force-locking connection, i.e., by a frictional or adhesive force. However, the formation of such a force-locking connection is not necessary for the magnetic connector according to the invention.

Since the magnetic force holding the magnetic connector on the mating connector depends on the one hand on the magnetization or magnetizability of the first contact and on the other hand on the amount of material of the first contact, the same effect is achieved independently of one another by the two above-mentioned structural options of the connector according to the invention (namely, on the one hand, the formation of the second contact from non-magnetized or less magnetized or magnetizable material and, on the other hand, the formation of the second contact from less material): A magnet assigned to the mating connector attracts the first contact of the connector exclusively or at least more strongly than the second contact. This ensures that the connector automatically aligns itself correctly when approaching the mating connector. This prevents accidental “polarity reversal” of the connector, in which the two contacts of the connector come into contact with the wrong contacts of the mating connector. This also prevents damage to the electronic device caused by reverse polarity.

Preferably, the first contact has a larger diameter than the second contact. In a preferred dimensioning, the diameter of the first contact is larger than the diameter of the second contact by a factor of between 1.5 and 4, preferably by a factor of between 2 and 3, and in particular by a factor of 2.5.

In an expedient embodiment, the first contact and the second contact are configured in such a way that their respective axes are aligned parallel to each other.

In a preferred embodiment, even better reverse polarity protection is achieved by the contact surface of the second contact protruding beyond the contact surface of the first contact—in particular when viewed transversely to an axis of the first contact. In other words, the second contact in this embodiment is longer than the first contact. In particular, this achieves the effect that when the connector approaches the mating connector, the first contact is still (slightly) spaced from the associated mating contact surface of the mating connector when the second contact is already touching the associated mating contact surface of the mating connector. A galvanic connection between the first contact and the associated mating contact surface is only created by the magnetic attraction force, which attracts the first contact of the connector to the associated mating contact surface, wherein the connector and/or the mating connector are slightly elastically deformed. If, on the other hand, the first contact of the connector is brought closer to the wrong mating contact surface, the magnetic attraction force is absent, which prevents a galvanic connection between the first contact of the connector and the wrong mating contact surface.

The above-mentioned elastic deformation of the connector and/or the mating connector when the first contact of the connector makes contact with the associated mating contact surface of the mating connector has the further effect that the second contact of the connector is pressed against the associated mating contact surface of the mating connector under elastic preload in the contacted state. This prevents a loose contact of the second contact.

In a preferred dimensioning, the second contact projects beyond the first contact—viewed in the direction of the axis of the first contact—for example by between 0.1 mm and 1 mm, preferably by between 0.2 mm and 0.6 mm and in particular by 0.4 mm.

In a variant of the embodiment described above, the mating contact surfaces of the mating connector are configured offset from one another, so that when the connector approaches the mating connector, the first contact is still (slightly) spaced from the corresponding mating contact surface when the second contact is already touching the associated mating contact surface.

In a further expedient embodiment of the connector, the first contact and the second contact are aligned at an angle to each other. In particular, the contacts are configured in such a way that the axis of the second contact is aligned at an angle of between 10° and 30°, in particular at an angle of 20°, to the axis of the first contact.

Preferably, the magnetic connector includes a carrier in which the first contact and the second contact are fixed relative to each other. In particular, the carrier is made of plastic (e.g. Vectra® E130i). In an advantageous embodiment, the carrier is formed by an injection-molded part. The first contact and the second contact are preferably embedded in the carrier (i.e., overmolded with the material of the carrier) or pressed into the carrier.

Furthermore, the first contact and the second contact of the connector are preferably fixed in the carrier in such a way that their respective connection surfaces are aligned flush with a rear side of the carrier, i.e., are neither set back from the rear side of the carrier nor protrude beyond the rear side of the carrier within the scope of usual manufacturing tolerances; this advantageously enables simple soldering of the connector to a printed circuit board of the electronic device by surface mounting technology (SMT; the magnetic connector is thus configured as an SMD component (surface-mounted device). The “connection surfaces” are those surfaces of the two contacts that are used to connect the contacts to the device's internal electrical conductors (in particular electrical supply lines of the charging connection). In particular, the connection surface is configured here in the opposite direction to the contact surface of the respective contact.

In an expedient embodiment, the magnetic connector includes, in addition to the two contacts and the carrier, a sealing layer made of an elastic material, e.g., a fluorosilicone, which is configured on a front side of the carrier so that it forms part of an outer housing side of the electronic device when the connector is in the mounted state. The sealing layer is formed, for example, by a part manufactured separately from the carrier, which in particular is plugged onto the contacts. Alternatively, the sealing layer is produced in one piece with the carrier, e.g. by 2K injection molding.

The magnetic mating connector according to the invention has two mating contacts that correspond to the contacts of the connector according to the invention, namely:
a first mating contact, which has the mating contact surface for forming a galvanic connection with the first contact of the connector, and
a second mating contact, which has the mating contact surface for forming a galvanic connection with the second contact of the connector.

The mating connector also includes a magnet, in particular a permanent magnet, which is aligned flush with the first mating contact.

The contact surface of the second mating contact is ring-shaped or ring-segment-shaped (in particular circular ring-shaped or circular ring-segment-shaped) and surrounds the first mating contact (in particular concentrically). This configuration of the mating connector has the effect that the connector can be rotated freely or at least within a predetermined angular interval around the first contact in the contacted state without losing the galvanic connection with the mating connector. This in turn leads to a considerable simplification of handling when connecting the connector to the mating connector. In an expedient embodiment, the mating contact surface of the first mating contact is also circular disk-shaped.

The mating contact surface of the first mating contact preferably has a diameter that is greater than a radial width of the mating contact surface of the second mating contact. For example, the diameter of the mating contact surface of the first mating contact is larger than the radial width of the mating contact surface of the second mating contact by a factor of between 1.5 and 4, preferably by a factor of between 2 and 3, and in particular by a factor of 2.5.

Other features which are considered as characteristic for the invention are set forth in the appended claims.

Although the invention is illustrated and described herein as embodied in a magnetic connector for a galvanic charging connection of an electronic device, in particular a hearing instrument, a magnetic mating connector, a magnetic connector system, an electronic device and a charger, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic plan view of a hearing instrument in the form of a hearing aid which can be worn behind a user's ear, and a charger into which the hearing instrument is inserted, wherein the hearing instrument has a galvanic charging connection with a magnetic connector which is in contact with a corresponding magnetic mating connector of the charger;

FIG. 2 is a (partially sectioned) side view of a magnetic connector system formed from the connector of the hearing instrument and the mating connector of the charger in a contacted state, wherein the connector has a first contact, a second contact and a carrier fixing the contacts, and wherein the mating connector has a first mating contact (corresponding to the first contact of the connector) and a second mating contact (corresponding to the second contact of the connector);

FIG. 3 is a perspective view of the connector system according to FIG. 2;

FIG. 4 is a perspective view of the connector of the magnetic connector system according to FIG. 2 with a view of a front side of the carrier and contact surfaces of the contacts;

FIG. 5 is a perspective view of the connector of the magnetic connector system according to FIG. 2 with a view of a rear side of the carrier and connection surfaces of the contacts (opposite the contact surfaces);

FIG. 6 is a (partially sectioned) side view of the connector of the magnetic connector system according to FIG. 2;

FIG. 7 is an exploded view of the connector of the connector system shown in FIG. 2 with an additional sealing layer;

FIG. 8 is a (partially sectioned) side view of the connector system according to FIG. 2 in a partially contacted state;

FIG. 9 is an exploded view of the connector system according to FIG. 2;

FIGS. 10 and 11 are a (partially sectioned) side view and perspective view of a second embodiment of the connector system;

FIG. 12 is a perspective view of the connector of the magnetic connector system according to FIG. 10 with a view of the front side of the carrier and the contact surfaces of the contacts;

FIG. 13 is a perspective view of the connector of the magnetic connector system according to FIG. 10 with a view of the rear of the carrier and the connection surfaces of the contacts;

FIG. 14 is a (partially sectioned) side view of the connector of the magnetic connector system according to FIG. 10;

FIG. 15 is an exploded view of the connector of the connector system according to FIG. 10 with an additional sealing layer;

FIG. 16 is an exploded view of the mating connector of the connector system according to FIG. 10;

FIGS. 17 and 18 are a perspective view and a longitudinal section of a third embodiment of the connector system; and

FIGS. 19 and 20 are a perspective view and a longitudinal section of a fourth embodiment of the connector system.

### DETAILED DESCRIPTION OF THE INVENTION

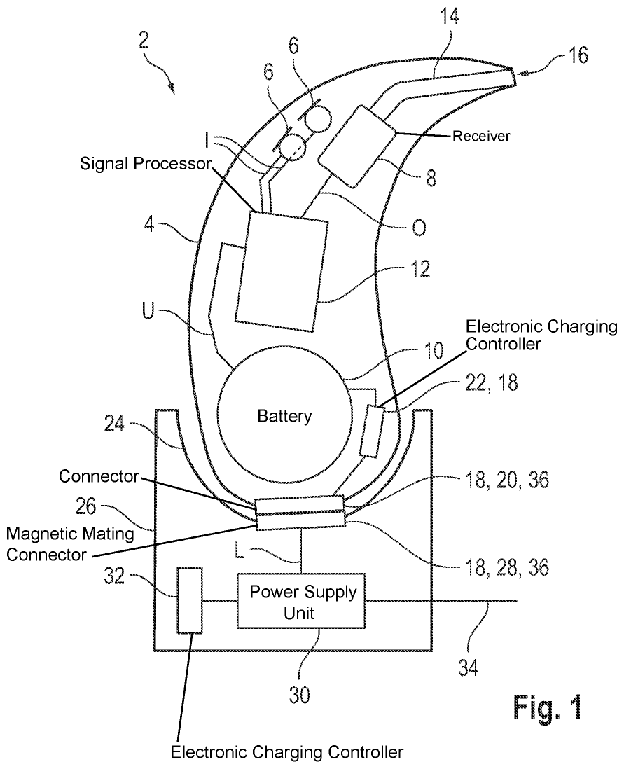

Referring now in detail to the figures of the drawings, in which corresponding parts and sizes are always marked with the same reference signs, and first, particularly, to FIG. 1 thereof, there is seen a hearing aid 2, i.e., a hearing instrument configured to support the hearing of a hearing-impaired user, as an example of an electronic device. In the example shown herein, the hearing aid 2 is a BTE hearing aid that can be worn behind a user's ear.

The hearing aid 2 includes, within a housing 4, at least one microphone 6 (here two microphones 6) as an input transducer and a receiver 8 as an output transducer. The hearing aid 2 further includes a battery 10 and a (in particular digital) signal processor 12. Preferably, the signal processor 12 includes both a programmable subunit (for example a microprocessor) and a non-programmable subunit (for example an ASIC).

The signal processor 12 is supplied with an electrical supply voltage U from the battery 10.

In normal operation of the hearing aid 2, the microphones 6 pick up an airborne sound from the surroundings of the hearing aid 2. The microphones 6 each convert the sound into an (input) audio signal I, which contains information about the recorded sound. The input audio signals I are fed within the hearing aid 2 to the signal processor 12, which modifies these input audio signals I to support the user's hearing.

The signal processor 12 outputs an output audio signal O, which contains information about the processed and thus modified sound, to the receiver 8.

The receiver 8 converts the output sound signal O into a modified airborne sound. This modified airborne sound is transmitted into the user's ear canal via a sound channel 14, which connects the receiver 8 to a tip 16 of the housing 4, and via a flexible sound tube (not explicitly shown), which connects the tip 16 to an earpiece inserted into the user's ear canal.

The battery 10 is a rechargeable battery. In order to charge the battery 10, the hearing aid 2 includes a galvanic charging connection 18. In the example shown, this charging connection 18 is substantially formed by a connector 20 and an electronic charging controller 22 of the hearing aid 2.

In order to charge the battery 10, the hearing aid 2 is inserted into a corresponding receptacle 24 of a charger 26, so that the connector 20 of the hearing aid 2 contacts a corresponding magnetic mating connector 28 of the charger 26.

Within the charger 26, the mating connector 28 is supplied with an electrical charging current L from a power supply unit 30. The power supply unit 30 is controlled by an electronic charging controller 32 of the charger 26 and obtains the electrical energy for generating the charging current L preferably via a mains cable 34 from a mains supply.

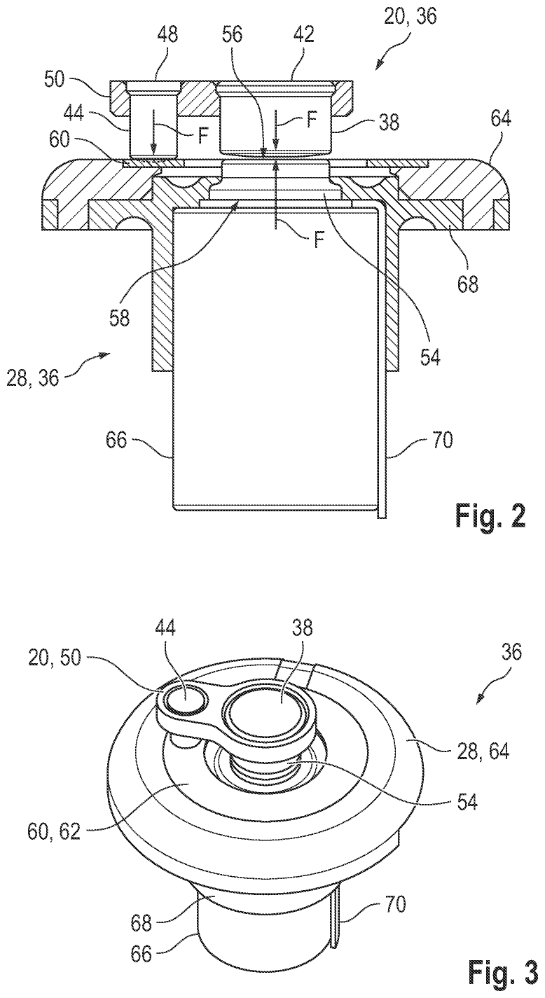

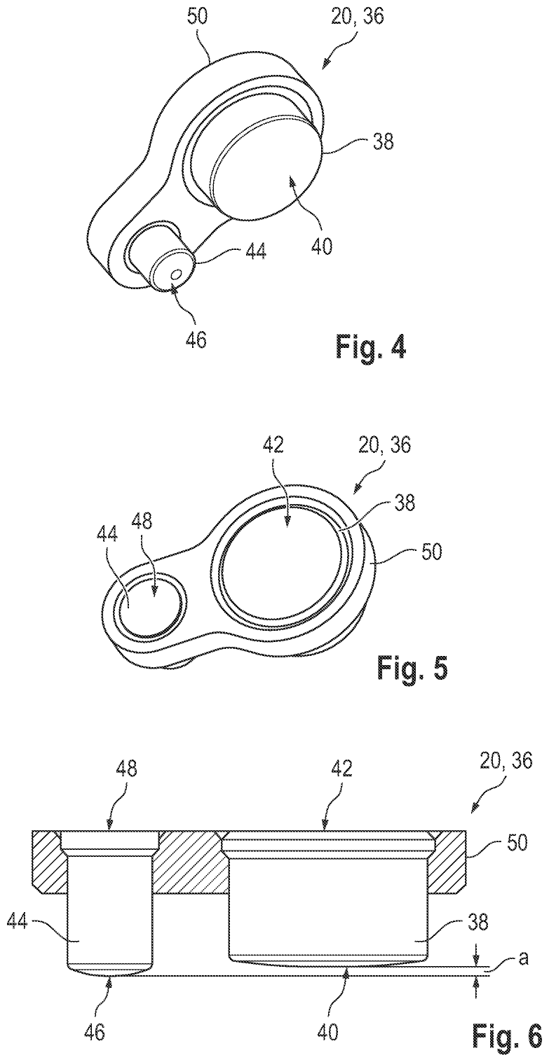

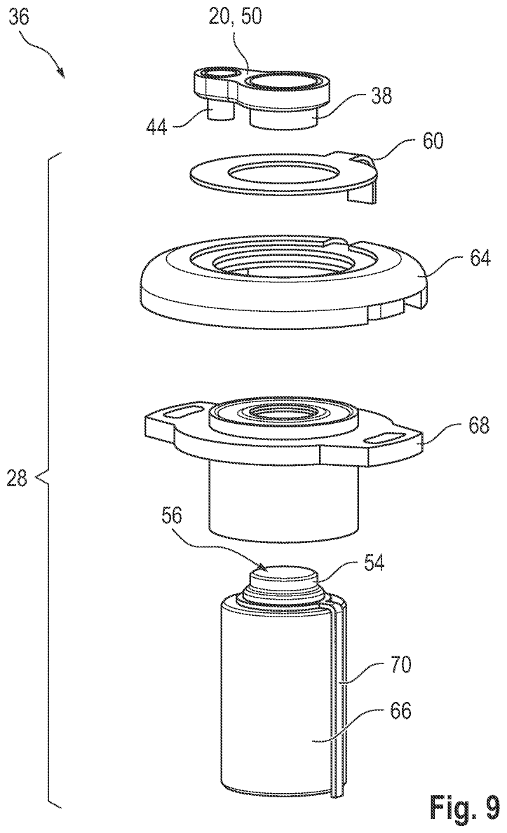

The connector 20 of the hearing aid 2 and the mating connector 28 of the charger 26 together form a connector system 36, which is shown in a first embodiment in FIGS. 2 to 9.

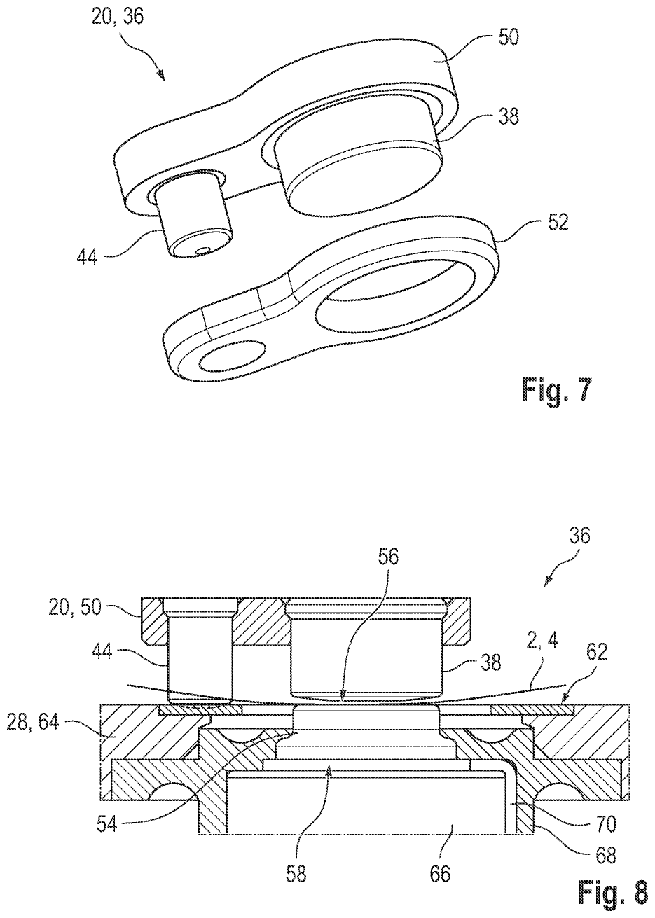

The hearing-aid-side connector 20 of this connector system 36 is configured with two poles and includes:
a cylindrical first contact 38 with a contact surface 40 and a connection surface 42 opposite it, which is formed of a magnetizable, electrically conductive material (for example SUS 430),
a cylindrical second contact 44 with a contact surface 46 and a connection surface 48 opposite it, which is formed of a non-magnetizable, electrically conductive material (for example TiAl4V6),
a carrier 50 made of plastic (for example Vectra® E130i), in which the contacts 38 and 44 are embedded and thus fixed relative to each other, so that the contacts 38 and 44 are configured parallel to each other with respect to their axes, and
optionally a sealing layer 52 (FIG. 7) made of an elastic material (for example fluorosilicone), which is pushed onto the contacts 38, 44.

FIGS. 2, 6 and 8 each show the carrier 50 in section.

The charger-side mating connector 28 of the connector system 36 as shown in FIGS. 2 to 9 is also configured with two poles and includes:
a roughly cylindrical first mating contact 54 with a mating contact surface 56 and a base surface 58 opposite to it, which is formed of a magnetizable, electrically conductive material (for example SUS 430),
a second mating contact 60 with a ring-shaped or ring-segment-shaped mating contact surface 62, which is formed from a non-magnetizable, electrically conductive sheet metal,
a mounting ring 64 made of plastic, which fixes the mating contacts 54 and 60 relative to each other in such a way that the second mating contact 60 concentrically surrounds the first mating contact 54,
a magnet 66, here in the form of a permanent magnet, which is aligned flush with the first counter-contact 54 and connects to its base surface 58, and
a pot-shaped pocket 68 made of elastic material (for example, a fluorosilicone), in the interior of which the magnet 66 is accommodated and held in a force-locking manner (i.e., by frictional forces).

In FIGS. 2 and 8, the mounting ring 64 and the pockets 68 are each shown in section.

The pocket 68 is configured here between the magnet 66 and the mounting ring 64. In its pot base, the pocket 68 is provided with an opening through which the first mating contact 54 protrudes. In the region of the base surface 58, the first mating contact 54 is widened. As a result, the first mating contact has a “magnetic funnel effect” in that it concentrates the magnetic flux emanating from the magnet 66. The first mating contact 54 is also connected via the base surface 58 to an electrical supply line 70, via which the first mating contact 54 is connected to the power supply unit 30 of the charger 26.

In order to improve the electrical conductivity, the contacts 38 and 44 as well as the mating contacts 56 and 60 are preferably provided with an electrically highly conductive coating, e.g., made of gold.

In particular, it can be seen from FIGS. 2 and 8 that the two mating contact surfaces 56 and 62 of the mating connector 28 lie in one plane in the exemplary embodiment according to FIGS. 2 to 9. Deviating from this, the two contact surfaces 40 and 46 of the connector 20 are offset from each other by a distance a (FIG. 6) of, for example, 0.5 mm in the axial direction of the contacts 38 and 44, since the second contact 44 is slightly longer than the first contact 38. As can be seen from FIG. 8, the contact surface 40 of the first contact 38 is set back slightly from the outside of the housing 4 (indicated in FIG. 8).

As can also be seen from FIG. 8, a gap is formed between the contact surface 40 of the first contact 38 and the corresponding mating contact surface 56 of the first mating contact 54 when the contact surface 46 of the second contact 44 abuts against the mating contact surface 62 of the second mating contact 60.

A contact (and thus a galvanic connection) between the contact surface 40 of the first contact 38 and the mating contact surface 56 of the first mating contact 54 is brought about here by the magnetic attraction of the first contact 38 by the magnet 66, by which the magnet 66 and the first mating contact 54 are slightly deflected with elastic deformation of the pocket 68 to close the gap described above. In the contacted state of the connector system 36 produced in this way, the second mating contact 60 is biased against the second contact 44 by the elastic deformation of the pocket 68.

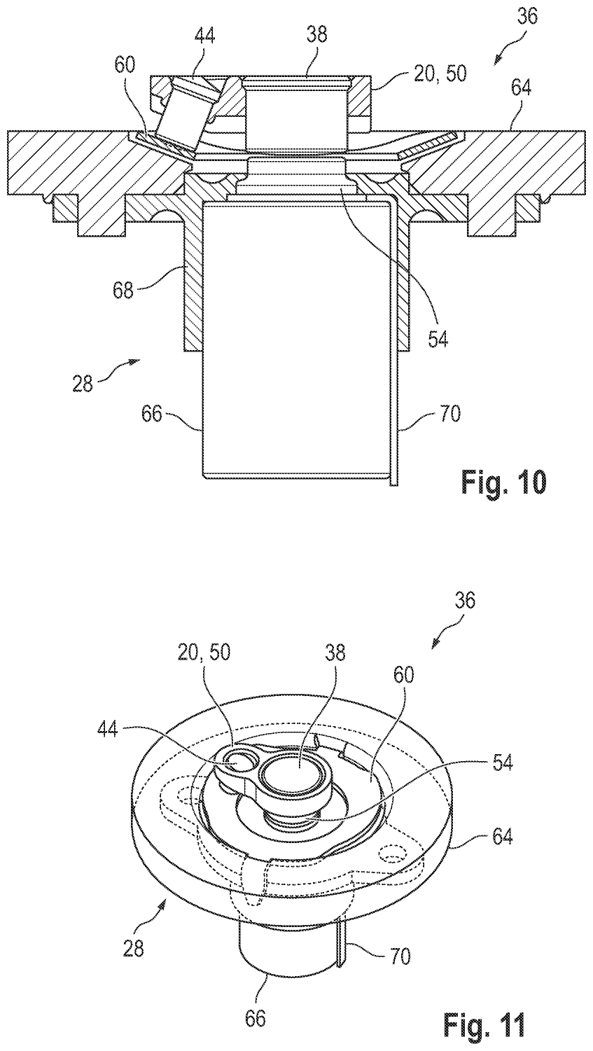

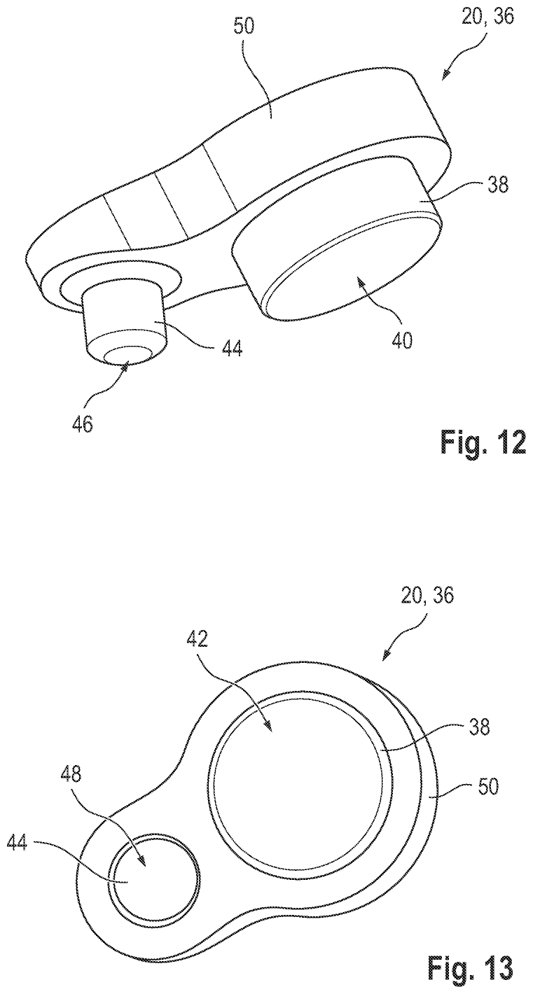

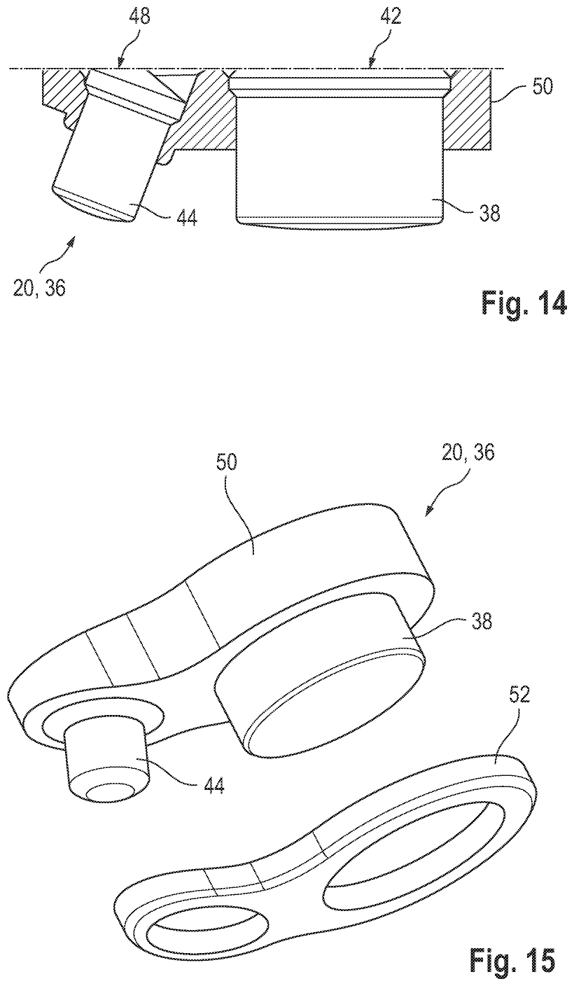

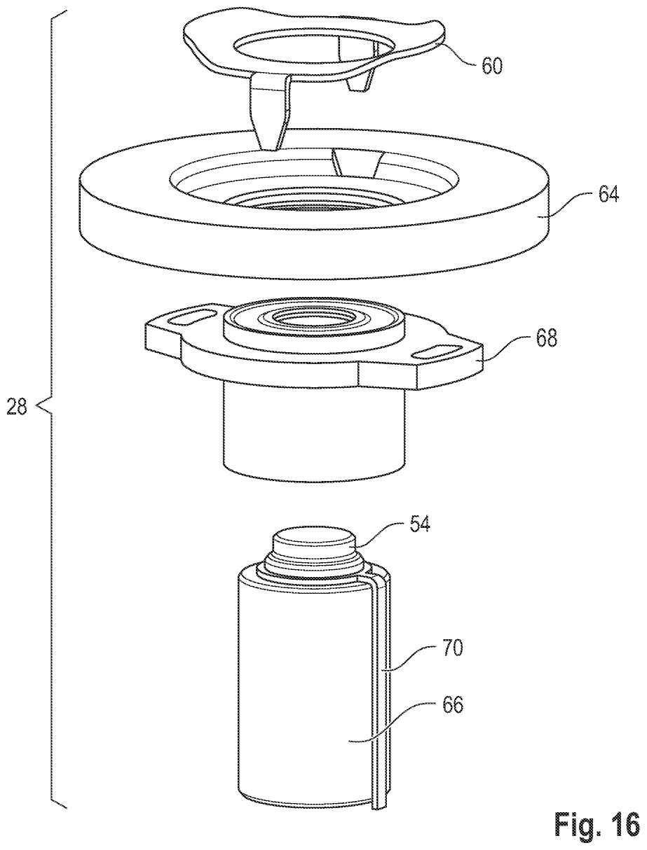

An alternative exemplary embodiment of the connector system 36 is shown in FIGS. 10 to 16. This connector system 36 differs from the exemplary embodiment shown in FIGS. 1 to 9 above all in that here the contacts 38 and 44 of the connector 20 are set at an angle of approximately 20° to one another with respect to their axes.

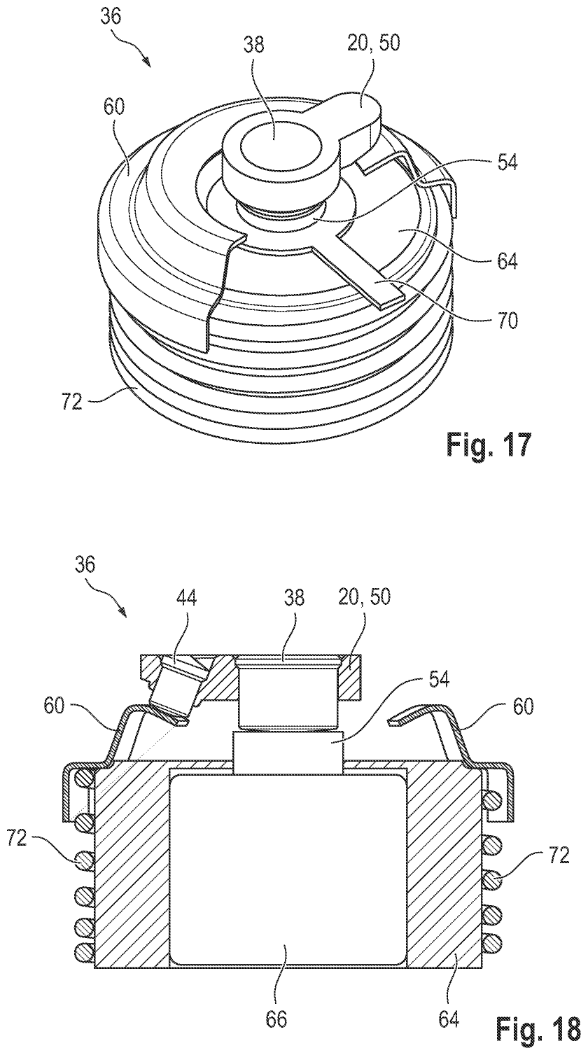

A third exemplary embodiment of the connector system 36 is shown in FIGS. 17 and 18. Here, instead of the elastic pocket 68, a helical spring 72 is provided, which is placed on the outside of the mounting ring 64 and, in the contacted state of the connector system 36, biases the second mating contact 60 against the second contact 44.

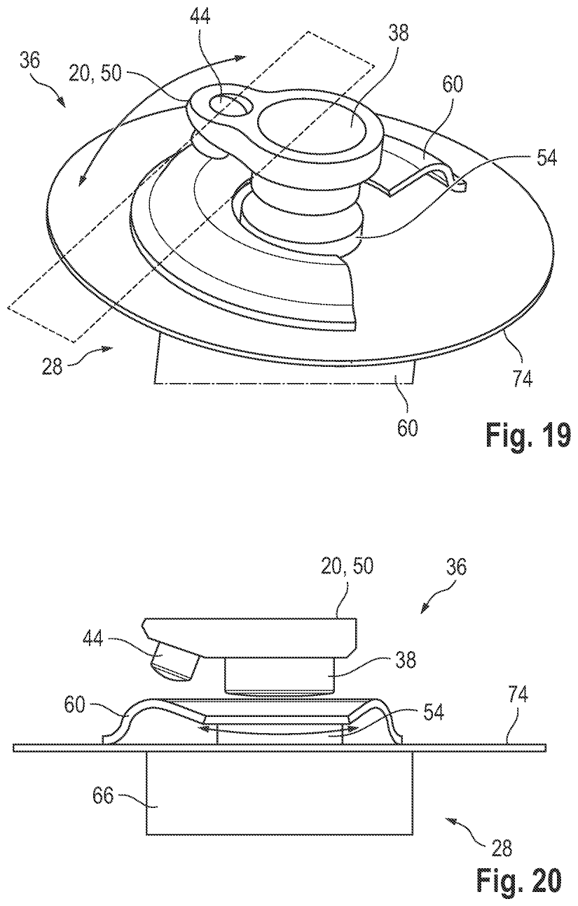

A fourth exemplary embodiment of the connector system 36 shown in FIGS. 19 and 20 differs from the exemplary embodiments described above primarily in that the first mating contact 54 and the second mating contact 60 of the mating connector 28 are mounted directly on a printed circuit board 74.

In further exemplary embodiments not shown in greater detail, the mating connector 28 is not integrated into the charger 26, but forms the end of a charging cable on the hearing aid side.

The invention becomes particularly clear from the exemplary embodiments described above, but is nevertheless not limited to these exemplary embodiments. Rather, further exemplary embodiments of the invention can be derived from the claims, the above description and the drawing. In particular, the details of the features of the invention shown in the individual exemplary embodiments can also be combined with each other in other ways.

The following is a summary list of reference numerals and the corresponding structure used in the above description of the invention.

### LIST OF REFERENCE SIGNS

2 hearing aid
4 housing
6 microphone
8 receiver
10 battery
12 signal processor
14 sound channel
16 tip
18 charging connection
20 (magnetic) connector
22 charging controller
24 receptacle
26 charger
28 (magnetic) mating connector
30 power supply unit
32 charging controller
34 mains cable
36 connector system
38 (first) contact
40 contact surface
42 connection surface
44 (second) contact
46 contact surface
48 connection surface
50 carriers
52 sealing layer
54 (first) mating contact
56 mating contact surface
58 base surface
60 (second) counter contact
62 counter contact surface
64 mounting ring
66 magnet
68 pocket
70 (electrical) supply line
72 coil spring
74 printed circuit board
a distance
I (input) audio signal
L charging current
O (output) audio signal
U supply voltage

1. A magnetic connector for a galvanic charging connection of an electronic device or a hearing instrument, the magnetic connector comprising:
a cylindrical first contact and a second contact disposed next to said first contact;
said first contact being formed of a magnetic or magnetizable material; and
said second contact being at least one of:
formed of a non-magnetic or non-magnetizable material or a material being less magnetizable than said material of said first contact, or
containing less material than said first contact.

2. The magnetic connector according to claim 1, wherein said material of said first contact is a ferrous steel, and said material of said second contact is a titanium alloy or an austenitic chromium-nickel-molybdenum steel.

3. The magnetic connector according to claim 1, wherein said first contact has a larger diameter than said second contact.

4. The magnetic connector according to claim 3, wherein said diameter of said first contact is larger than said diameter of said second contact by a factor of between 1.5 and 4.

5. The magnetic connector according to claim 3, wherein said diameter of said first contact is larger than said diameter of said second contact by a factor of between 2 and 3.

6. The magnetic connector according to claim 3, wherein said diameter of said first contact is larger than said diameter of said second contact by a factor of 2.5.

7. The magnetic connector according to claim 1, wherein said first contact and said second contact have respective axes aligned parallel to each other.

8. The magnetic connector according to claim 7, wherein said first contact and said second contact each have a respective contact surface for forming a galvanic connection with a magnetic mating connector of a charger or charging cable, and said contact surface of said second contact projects beyond said contact surface of said first contact.

9. The magnetic connector according to claim 1, wherein said first contact and said second contact are aligned at an angle relative to each other.

10. The magnetic connector according to claim 1, which further comprises a carrier (50 in which said first contact and said second contact are fixed relative to each other.

11. The magnetic connector according to claim 10, wherein said carrier, is made of plastic.

12. The magnetic connector according to claim 10, wherein:
said carrier has a rear side;
said first contact and said second contact each have a connecting surface disposed opposite said contact surface of said respective contact; and
said first contact and said second contact are fixed in said carrier with said connecting surfaces aligned flush with said rear side of said carrier.

13. The magnetic connector according to claim 10, wherein said carrier has a front side with an elastic sealing layer forming a part of a housing outer side of the electronic device when the connector is in a mounted state.

14. The magnetic connector according to claim 13, wherein said elastic sealing layer is made of a fluorosilicone.

15. A magnetic mating connector of an electrical charger or charging cable, the magnetic mating connector comprising:
a first mating contact having a mating contact surface for forming a galvanic connection with a first contact of a magnetic connector of a charging connection of an electronic device;
a second mating contact having a mating contact surface for forming a galvanic connection with a second contact of the connector of the charging connection of the electronic device; and
a magnet or a permanent magnet aligned flush with said first mating contact;
said mating contact surface of said second mating contact being ring-shaped or ring-segment-shaped and surrounding said first mating contact.

16. The magnetic mating connector according to claim 15, wherein said mating contact surface of said second mating contact has a radial width, and said mating contact surface of said first mating contact has a diameter being larger than said radial width of said mating contact surface of said second mating contact.

17. The magnetic mating connector according to claim 16, wherein said diameter of said mating contact surface of said first mating contact is larger than said radial width of said mating contact surface of said second mating contact by a factor of between 1.5 and 4.

18. The magnetic mating connector according to claim 16, wherein said diameter of said mating contact surface of said first mating contact is larger than said radial width of said mating contact surface of said second mating contact by a factor of between 2 and 3.

19. The magnetic mating connector according to claim 16, wherein said diameter of said mating contact surface of said first mating contact is larger than said radial width of said mating contact surface of said second mating contact by a factor of 2.5.

20. A magnetic connector system, comprising:
the magnetic connector according to claim 1; and
a magnetic mating connector of an electrical charger or charging cable, said magnetic mating connector cooperating with the magnetic connector to establish an at least two-pole galvanic connection;
said magnetic mating connector including:
a first mating contact having a mating contact surface for forming a galvanic connection with said first contact of the magnetic connector;
a second mating contact having a mating contact surface for forming a galvanic connection with said second contact of the connector; and
a magnet or a permanent magnet aligned flush with said first mating contact;
said mating contact surface of said second mating contact being ring-shaped or ring-segment-shaped and surrounding said first mating contact.

21. An electronic device or hearing instrument, comprising:
a rechargeable battery; and
a galvanic charging connection for supplying an electric current for charging the battery;
said galvanic charging connection having the magnetic connector according to claim 1 for producing a galvanic contact, held by magnetic force, with a magnetic mating connector of a charger or charging cable.

22. A charger or charging cable for supplying an electronic device or hearing instrument with electric current for charging a rechargeable battery of the electronic device, the charger or charging cable comprising the magnetic mating connector according to claim 15.
